(19) United States
(12) Patent Application Publication
(10) Pub. No.: US 2012/0283380 A1
(43) Pub. Date: Nov. 8, 2012

(54) RUBBER MIXTURE FOR ELASTIC COUPLING

(75) Inventor: Ralf Bauermeister, Herten (DE)

(73) Assignee: HACKFORTH GmbH, Herne (DE)

(21) Appl. No.: 13/505,556

(22) PCT Filed: Nov. 3, 2010
(86) PCT No.: PCT/EP10/06695

§ 371 Date: Jun. 12, 2012

(30) Foreign Application Priority Data
Nov. 3, 2009 (DE) 10 2009 051 778.2

(51) Int. Cl. C08K 3/36; C08L 7/00; C08L 9/00

(52) U.S. Cl. 524/575.5; 524/571

(57) ABSTRACT

The invention relates to an elastic coupling comprised of connecting flanges located on the drive input and drive output side as well as comprised of at least one rubber .body arranged between them. The invention proposes that the at least one rubber body contains silicic acid/silica as filler agent as well as dyeing pigments.

The invention relates to an elastic coupling comprised of connecting flanges located on the drive input and output side as well as comprised of at least one rubber body arranged between them.

Elastic couplings are known from prior art, e.g. from DE 199 55 051 A1. Couplings of this kind are equipped with elastic rubber bodies which in most cases are comprised of various caoutchouc components, soot, and other additives as well as softeners. The rubber body is vulcanized in order to achieve permanently elastic properties and thus it is concurrently connected to coupling flanges located on the drive input and output side. The constituents are properly harmonized to each other so as to obtain optimal behavior versus the forces attacking at the coupling. Such forces include but are not limited to shear and/or torsion forces which attack at the opposite connecting flanges of the coupling and thus exert strains and stresses on the rubber body.

Printed publication DE 44 22 048 A1 discloses a torsionally elastic clutch comprised of peroxidic crosslinked silicone caoutchouc which is particularly distinguished by high temperature stability, better resistivity versus ageing, and increased mechanical strength. Silica is utilized to serve as active filler material as is mostly done with dynamically strained silicone elastomers: Conversely, the application of soot would cause a noticeably lesser reinforcement.

Proceeding from prior art in technology as mentioned hereinabove, it is desirable to achieve an improvement in the mechanical strength of elastic couplings equipped with rubber bodies made of caoutchouc and/or polyisoprene.

Now, therefore, it is the task of the present invention to provide an elastic coupling, the rubber body of which features improved mechanical properties.

To solve this task, the present invention proposes that the at least one rubber body contains
silicic acid/silica as filler agent, and
dyeing pigments.

The invention is distinguished by the fact that silicic acid and/or silica rather than soot are utilized in the manufacture of the rubber body, though maintaining the use of conventionally sulfur-crosslinked caoutchouc material, that means preferably natural caoutchouc or polyisoprene. It becomes evident that it is thereby possible to significantly improve the mechanical properties of the coupling, e.g. the tear propagation strength of the rubber body.

Here, particulate, silanized silica/silicic acid material is preferably used as filler agent. It yields the advantage that tensile strength and elongation at break are increased while compression set (DVR) is decreased.

Another advantage is that even the color of the rubber body can be varied. To date, the color has always been black because the rubber mixtures made of natural caoutchouc applied with elastic couplings in principle contain soot serving as filler agent. Dyeing has not been provided for.

Hence, silicic acid/silica is suitable to improve resistance to tear propagation of the filled rubber material as compared with rubber material filled with soot on the one hand and on the other hand the inventive filler agent is colorless, thus allowing for the use of dyeing pigments. A dyeing of the rubber material can be utilized in order to identify the relevant mechanical properties or the special layout of the coupling (transferrable torque, transferrable performance output, etc.).

One embodiment of the elastic coupling provides for a homogeneous distribution of the silicic acid in the rubber body. With this variant, homogeneous material properties are obtained over the entire volume of the rubber body.

One variant provides for distributing the dyeing pigments homogeneously in the rubber mixture. It represents the simplest variant, especially in terms of manufacturing techniques.

Preferably the rubber body contains 20-90% silicic acid/silica relative to the total mass of the rubber body.

Furthermore, the rubber body preferably contains less than 5% soot relative to the total mass of the rubber body. Especially preferably the rubber mixture should contain no soot at all, but less than 1% soot in order to achieve optimal colorability of the rubber body.

Moreover, the inventive coupling can be combined with ordinary heat stabilizers.

1. Elastic coupling comprised of connecting flanges located on the drive input and drive output side and comprised of at least one rubber body arranged between them, wherein, the at least one rubber body contains
silicic acid/silica as filler agent, and
dyeing pigments.

2. Elastic coupling according to claim 1, wherein the rubber body is made of natural caoutchouc and/or polyisoprene.

3. Elastic coupling according to claim 2, wherein the rubber body is manufactured by sulfur vulcanization.

4. Elastic coupling according to claim 1, wherein the rubber body contains silicic acid/silica in form of particles.

5. Elastic coupling according to claim 4, wherein the silicic acid/silica particles are at least partly silanized.

6. Elastic coupling according to claim 5, wherein the silicic acid/silica particles are homogeneously distributed in the rubber body.

7. Elastic coupling according to claim 1, wherein the dyeing pigments are homogeneously distributed in the rubber body.

8. Elastic coupling according to claim 1, wherein the rubber body contains 20-90% silicic acid/silica.

9. Elastic coupling according to claim 1, wherein the rubber body contains less than 5% soot.
